(19) United States
(12) Patent Application Publication
(10) Pub. No.: US 2024/0383430 A1
(43) Pub. Date: Nov. 21, 2024

(54) METHOD FOR TRIGGERING OCCUPANT PROTECTION DEVICES IN A MOTOR VEHICLE

(71) Applicant: Continental Automotive Technologies GmbH, Hannover (DE)

(72) Inventors: Gabriel Marin, Timisoara (RO); Ioana Stefana Comanescu, Mosnita Noua (RO)

(73) Assignee: Continental Automotive Technologies GmbH, Hannover (DE)

(21) Appl. No.: 18/570,308

(22) PCT Filed: Jun. 9, 2022
(86) PCT No.: PCT/DE2022/200109

§ 371 Date: Dec. 14, 2023

(30) Foreign Application Priority Data
Jun. 21, 2021 (EP) 21465529.2
Jun. 22, 2021 (DE) 10 2021 206 363.2

(51) Int. Cl. B60R 21/0136

(52) U.S. Cl. CPC B60R 21/0136

(57) ABSTRACT

A method for triggering occupant protection devices in a motor vehicle based on a right-hand upfront sensor, a left-hand upfront sensor, and a central impact sensor. The signals are compared with thresholds, and the impact type and the degree of impact severity are derived therefrom. Trigger paths with different criteria are provided, and a decision is made regarding the triggering of the occupant protection devices as a function thereof.

### CROSS-REFERENCE TO RELATED APPLICATIONS

The present application is a National Stage Application under 35 U.S.C. § 371 of International Patent Application No. PCT/DE2022/200109 filed on Jun. 9, 2022, and claims priority from German Patent Application No. 10 2021 206 363.2 filed on Jun. 22, 2021, in the German Patent and Trademark Office, and the European Patent Application No. 21465529.2, filed on Jun. 21, 2021, in the European Patent Office, the disclosures of which are herein incorporated by reference in their entireties.

### BACKGROUND

### 1. Field

Embodiments of the present application relate to a method for triggering occupant protection devices in a motor vehicle on the basis of the signals of at least one right-hand and at least one left-hand upfront sensor as well as the signal of at least one impact sensor arranged centrally in the vehicle.

### 2. Description of Related Art

The triggering of occupant protection devices in a motor vehicle on the basis of the signals of at least one right-hand and at least one left-hand upfront sensor as well as the signal of at least one impact sensor arranged centrally in the vehicle has been known per se for decades, wherein the signals are compared with thresholds, and the impact type and the degree of impact severity are derived therefrom. A plurality of trigger paths with different criteria are provided in order to do justice, for example, to the different impact types or requirements of the decision for a triggering and a non-triggering of specific occupant protection devices and in terms of the triggering time. It is precisely the partial overlaps in the signal behavior between triggering and non-triggering cases, as well as the requirement for the earliest possible triggering decision and, therefore, a differentiation between cases which lead to the plurality of the trigger paths and the respective optimization. As a general rule, acceleration sensors which are centrally integrated in the control unit of the occupant protection system are deployed as central impact sensors in the vehicle, wherein the use of central acceleration sensors of other control units or of a sensor cluster is also conceivable. In addition to acceleration sensors, various other forms of impact sensors, for example including pressure sensors, for detecting pressure changes caused by a collision inside a cavity such as, for example, an elastic hose are also known for the so-called upfront sensors, that is to say, sensors located in the front of the vehicle, for example in the region of the bumper.

For example, EP 1028039 A2 describes an activation control device of an occupant safety system for controlling the activation of the occupant safety system mounted on a vehicle in the event of the vehicle colliding with an obstacle, wherein the activation control device has a plurality of upfront sensors, that is to say impact detecting means, which are positioned at multiple different positions in a front section of the vehicle. Additionally, collision type identifying means for identifying a type of collision of the vehicle, based on values which are detected by the plurality of impact detecting means, are already known per se. The collision type identifying means identifies the type of collision as an oblique crash if, after the collision of the vehicle, there is a time difference between increases in the values which are detected by the right-hand and left-hand impact detecting means.

A method for recognizing a width of an impact region of an object in the front region of a vehicle is proposed in EP 2504201 A1, which has a step of receiving a first deformation element signal which represents a change in the distance of components of a first deformation element from one another, which is installed in the left-hand front region of the vehicle. Furthermore, the method comprises a step of receiving a second deformation element signal which represents a change in the distance of components of a second deformation element from one another, which is installed in the right-hand front region of the vehicle. Finally, these two deformation elements with their corresponding sensors also constitute a configuration of upfront sensors.

An offset collision with a small width of an impact region of the object on the vehicle is recognized if the first deformation element signal differs by more than a specified threshold value level from the second deformation element signal.

### SUMMARY

Aspects and objects of the embodiments of the present application include to further increase safety in road traffic and to present a method which makes it possible to trigger specific selected occupant protection devices early and, at the same time, safely in specific oblique impact events with the appropriate intensity, without also responding, at the same time, in typical non-triggering cases or total triggering cases which are known per se. Oblique impact events involving high collision energy, that is to say a high relative speed between the collision objects, require a very particular optimization of the protective effect of specific occupant protection devices, that is to say the triggering thereof is defined earlier than in the previously known crash scenarios or trigger paths.

As the crash progresses, such high-energy oblique impact events also of course lead, as a general rule, to the total triggering of all the occupant protection devices, but the previous trigger paths and criteria are not suitable for the necessary, particularly early triggering decision for the specific occupant protection devices.

Aspects and objects of the embodiments of the present application may consider that the signals of the two upfront sensors are evaluated with respect to the signal of the central sensor and, in addition, this relationship is evaluated at the same time with respect to the two upfront sensors.

According to an aspect of an embodiment, in the trigger path an early triggering of a specified selection of occupant protection devices is carried out if the signal of one of the two upfront sensors already exceeds a second threshold value with respect to the signal of the central sensor while the signal of the other upfront sensor still lies below a first threshold value with respect to the signal of the central sensor and, additionally, the signal of the upfront sensor which exceeds the second threshold with respect to the signal of the central sensor additionally exceeds a specified characteristic. It should be pointed out again that there is, of course, usually a plurality of further trigger paths and the threshold values there are different and then become active for other triggering cases.

The specified characteristic preferably has at least one first section as long as the signal of the central sensor is at least less than a specified limit value and a triggering is carried out in this section if one of the two upfront sensors exceeds the second threshold while the other upfront sensor is still below the first threshold; otherwise, no triggering is carried out in this section via this trigger path and this section. Additionally, at least one further section is provided, in which the triggering via this trigger path is suppressed as soon as the signal of the central sensor is greater than a specified limit value.

The background to this restriction is that, as of a certain degree of crash severity, a selective, early triggering of these specific occupant protection devices is no longer necessary and, on the other hand, there is a risk that the signals per se would then otherwise enter the triggering range for the various other impact cases as well.

In a further development, in addition to the two sections, a further, middle section is provided, in which the second threshold value for the upfront sensor, as of which a triggering is carried out, also increases as the value for the central sensor increases, that is to say that the two sections are virtually transferred into one another via this middle section.

The signal of the two upfront sensors is preferably integrated via a short-time integral while the signal of the central sensor is fed to a double integration and the signals thus obtained are evaluated with respect to one another. From a purely physical point of view, this may not be expected, however this unequal treatment is advantageous for crash recognition in this case.

The method is preferably used in order to trigger a first of a plurality of stages of a driver and/or front passenger airbag as well as a side or window airbag on that side where the upfront sensor shows the signal of the corresponding size.

Accordingly, a control unit for occupant protection devices has corresponding connections for the occupant protection devices as well as connections for the signals of at least two upfront sensors as well as at least one central impact sensor, as well as having a memory which includes an algorithm for performing the method according to an embodiment. Obviously, further trigger paths are also implemented in the algorithm.

### BRIEF DESCRIPTION OF THE DRAWINGS

The embodiments of the present application will be explained in greater detail below based on exemplary embodiments with reference to the figures.

FIGS. 1A-E are diagrams illustrating an occupant protection system for a motor vehicle;

FIGS. 2A-E are graphs illustrating a course of signals of sensors of an occupant protection system;

FIGS. 3A-D are graphs illustrating a course of signals of sensors of an occupant protection system;

FIGS. 4A-D are graphs illustrating a course of signals of sensors of an occupant protection system;

FIGS. 5A-D are graphs illustrating a course of signals of sensors of an occupant protection system; and

FIGS. 6A-D are graphs illustrating a course of signals of sensors of an occupant protection system.

### DETAILED DESCRIPTION

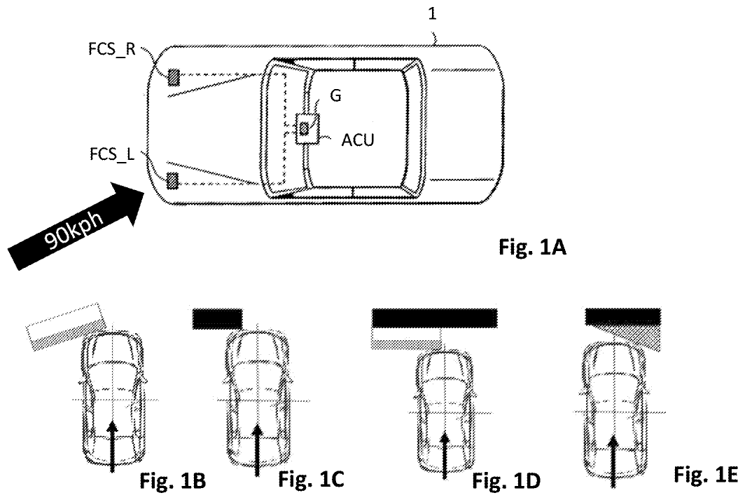

FIG. 1A shows a known construction of an occupant protection system for a motor vehicle having a central control unit for occupant protection devices ACU as well as integrated at least one impact sensor G as well as an upfront sensor FCS_R arranged on the right-hand side as well as an upfront sensor FCS_L arranged on the left-hand side with regard to the direction of travel. In addition to these, further sensors can be installed in the front region, side region or centrally in the vehicle, in particular also have axes of sensitivity other than those only which are directed in the direction of travel, however reference is made to the signal component thereof in the direction of travel for the relevant method here.

The various occupant protection devices in the vehicle are not shown for the sake of simplicity, but are indeed known per se from the prior art.

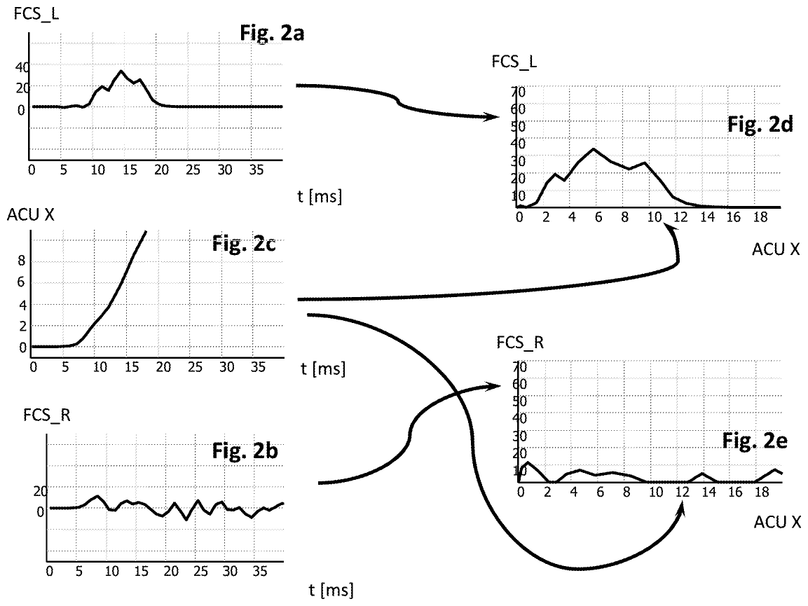

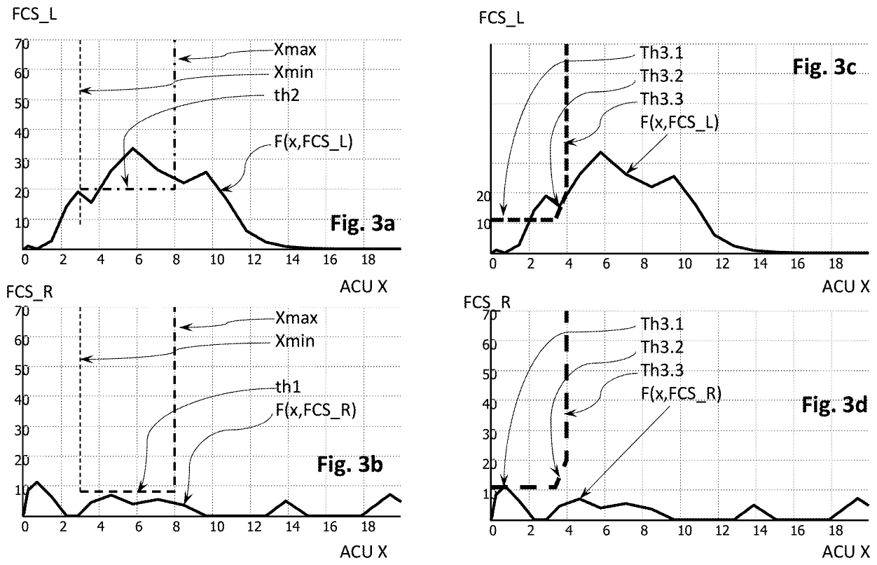

Additionally, an oblique impact at 90 km/h (=kph) is visualized in an outline form in FIG. 1A, for which FIGS. 2 and 3 also depict the corresponding signal courses below. FIG. 1B shows in somewhat more detail the relevant crash test arrangement of a so-called oblique test which, as of a specific intensity, triggers the activation of the airbags laterally protecting the body, in particular the head, that is to say, e.g., side, window or so-called curtain airbags, particularly early on.

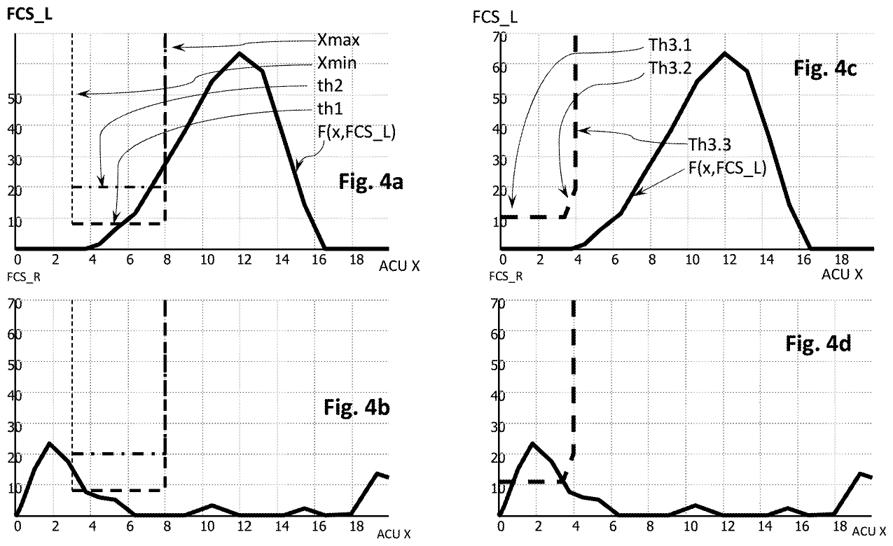

By contrast, FIG. 1C shows a so-called SOT Small Overlap Test, for which the signal course is also explained in FIG. 4.

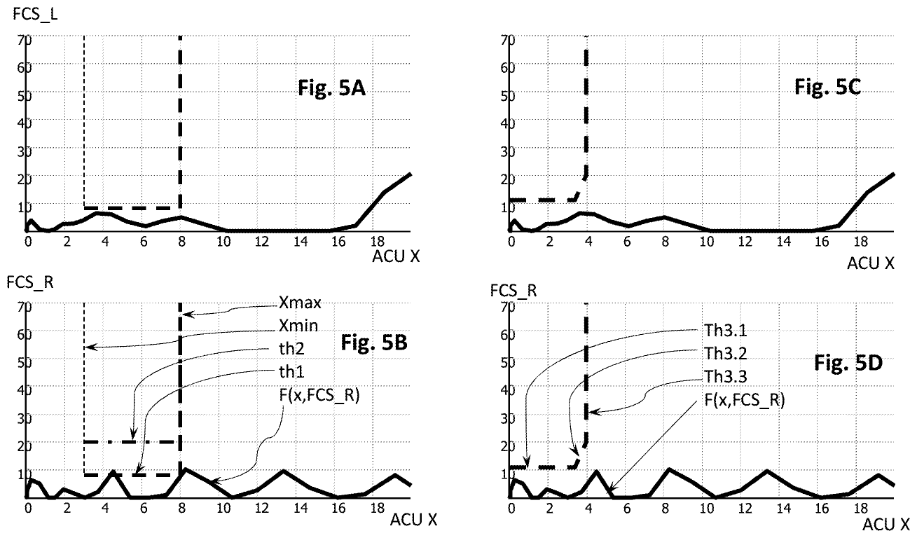

By contrast, FIG. 1D shows a so-called ODB Offset Deformable Barrier Test, that is to say a deformable barrier which is additionally only partially hit and for which the signal course is explained in FIG. 5.

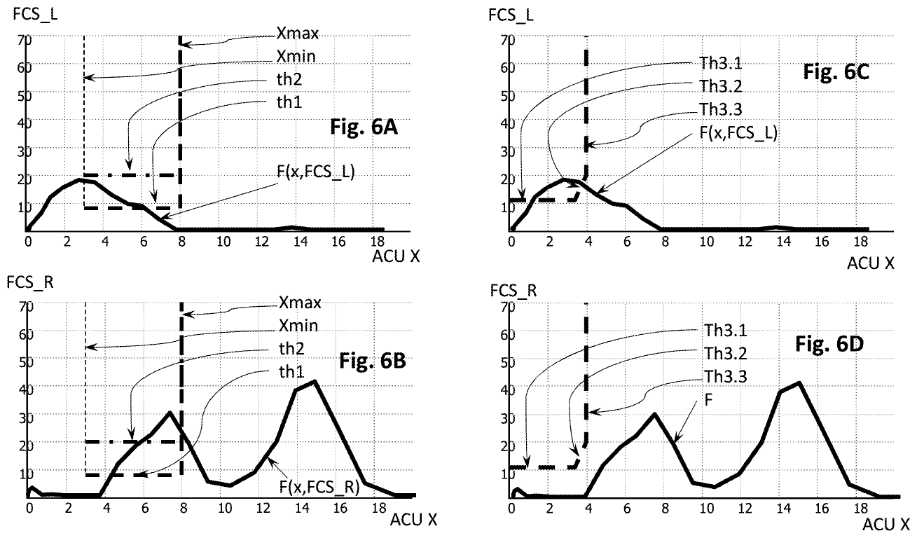

By contrast, FIG. 1E shows another form of an oblique impact, for which the signal course is explained in FIG. 6.

FIGS. 2A to 2C now outline the course of the signals of the two upfront sensors FCS_L and FCS_R as well as the double integral value X derived from the central impact sensor G in the central airbag control unit ACU for the inherently very early and short time window of 0 to 35 ms as of the start of the collision in the case of a particularly critical oblique test. However, as already described above, the signals are not compared with a threshold based on time, but rather are evaluated with respect to the signal of the central impact sensor. Thus, FIGS. 2D and 2E show the value X of the double integral of the central impact sensor plotted on their X-axis and the value of the short-time integral of the respective upfront sensors on their Y-axis. Therefore, the signal course changes with respect to the signal of the central impact sensor in terms of the course. FIGS. 2A to 2E purely serve to illustrate and visualize the derivation of this synopsis from the respective time courses of the sensor signals based on this impact event.

FIGS. 3A to 3D now illustrate in outline form the evaluation of this synopsis below, wherein FIGS. 3A and 3C show the course of the short-time integral of the signal of the left-hand upfront sensor FCS_L, and FIGS. 3B and 3D show the course of the short-time integral of the signal of the right-hand upfront sensor FCS_R.

FIGS. 3A and 3B illustrate the evaluation in terms of the offset characteristic with the 1st and 2nd threshold values th1<th2, wherein for the side affected by the impact, that is to say the left-hand side in this case, the 2nd, that is to say the higher threshold value th2 (drawn with a dashed-dotted line in the figures), must be exceeded while, on the opposite side, that is to say the right-hand side in this case, the signal is still below a first threshold value th1 (shown dashed in the figures). For the sake of clarity, only the appropriate threshold value has been shown in each case in FIGS. 3A and 3B—but, functionally, the signals are of course always evaluated in parallel with regard to all of the threshold values. Even the second threshold value is very low, but very early with respect to the signal of the central sensor G, that is to say, the signal ACU X, which is then indicative again of the particular degree of crash severity.

In the preferred exemplary embodiment outlined here, a lower limit Xmin and an upper limit Xmax are additionally applied to this trigger path. The aim of the lower limit Xmin is to compensate for or eliminate the signal fluctuations which can sometimes be physically difficult to explain, especially at the beginning of the impact, and to avoid false triggerings.

On the other hand, the upper limit Xmax limits the application of this trigger path to the particular oblique impact cases of particular intensity. These FIGS. 3A and 3B can virtually be understood to be offset mapping, wherein this alone is not sufficient for distinguishing between cases and the further criterion for the purpose of evaluation with regard to the demarcation in terms of the severity of the oblique impact and with respect to other offset cases is purely outlined, for the sake of clarity, in the separate FIGS. 3C and 3D.

In order to trigger those specific occupant protection devices which are to be triggered particularly early, the signal of the upfront sensor hit more directly by the impact (here, FCS_L in the case according to FIGS. 1-3), which namely exceeds the second threshold (th2) with respect to the signal of the central sensor (G), must additionally exceed a specified characteristic (th3).

The specified characteristic (th3) expressly demarcates a triggering range, which is also filled with dots, from the remaining non-triggering range exclusively for this trigger path, i.e., signals of corresponding sizes, especially on the central sensor, would, as the crash subsequently proceeds, obviously also lead to triggering, of course, right up to the total triggering of the entire occupant protection system; however, the characteristic specified here is precisely optimized for the particularly early triggering of these severe oblique impact crashes. In this preferred configuration, this characteristic th3 has the first section (th3.1) as long as the signal of the central sensor (G) is at least less than a specified limit value (2.5) and, in this section th3.1, a triggering is carried out if one of the two upfront sensors (FCS_L) also exceeds the characteristic th3. Purely for the sake of completeness, it should again be clarified that all three criteria must of course be met, i.e., in addition to the characteristic th3, the upfront sensor (FCS_L) in question must also exceed the second threshold (th2) while the other upfront sensor (FCS_R) is still below the first threshold (th1); otherwise, no triggering is carried out in this section (th3.1) via this trigger path and this section (th3.1)—as indeed already explained above with respect to FIGS. 3A and 3B, and purely for the sake of clarity, this is illustrated in exploded view here in the figures in order to make it much clearer.

In this configuration, at least one further section (th3.3) is provided, in which the triggering via this trigger path is suppressed as soon as the signal of the central sensor (G) is greater than a specified limit value. Moreover, in addition to the two sections, FIGS. 3C and 3D show a further middle section th3.2, in which the second threshold value for the upfront sensor (FCS_L, FCS_R), as of which the triggering is carried out, also increases as the value for the central sensor (G) increases, as the figures do make clear.

As already explained above, FIGS. 3A to 3D therefore show the typical course of an oblique collision of particular severity, for which a particularly early triggering comprises the specified selection of occupant protection devices, indeed, in particular, exclusively a first of a plurality of stages of a driver and/or front passenger airbag as well as a side or window airbag on that side, and is triggered precisely on that side where the upfront sensor (FCS_L) shows the signal of the corresponding size. Thus, FIG. 3A shows the corresponding function course F on the left and the exceeding of the 2nd, higher threshold value, while in FIG. 3B the signal of the right-hand upfront sensor lies within the relevant range between Xmin and Xmax below the 1st threshold value. Additionally, the function course for the left-hand side also meets the characteristic th3 at a value of ACU X=2-4 in FIG. 3C. FIG. 3D is also depicted purely for the sake of completeness, but is not significant for the triggering decision in this exemplary embodiment or impact events. It is true that the actual time courses and the amplitude level are obtained from real simulations, but are only intended as examples and to clarify the function in principle.

The following FIG. 4 et seq. now outline further, different crash courses for the exemplary embodiment and are intended to outline the method of operation and demarcation of the triggering decision for this triggering case in more detail, but reference is made accordingly to FIGS. 3A to 3D, which have already been explained in detail.

Thus, FIGS. 4A to 4D show a so-called SOT at 64 kph, a small overlap test according to FIG. 1c, that is to say rather a frontal crash which likewise has not inconsiderable speed or energy, but which does not have the comparable component in the transverse direction to the direction of travel and, therefore, this particularly sensitive trigger path shall not be applied. Accordingly, it is true that the signal course on the hit side on the left-hand side is again above the second threshold value th2 in FIG. 4A, the third characteristic th3 within the triggering window (dotted) is not met on this side of the vehicle on the left-hand side, even if the degree of severity is of course very clear on the central sensor as well, as the crash subsequently progresses—but then other trigger paths intervene.

FIGS. 4B and 4D additionally show the atypical signals, again, which can only be explained by indirect deformations of the front of the vehicle and which are by no means negligible on the side which was not actually hit, the right-hand side here, wherein these do not form part of the triggering decision, in part, due to the limitation Xmin. It is once again important to clarify that even exceeding the characteristic th3 is not sufficient (here, in FIG. 4D), but rather that th2 would also have to be triggered for this very side, which is not, however, the case according to FIG. 4B.

FIGS. 5A to 5D show a so-called 64 kph ODB=Offset Deformable Barrier Test (cf. FIG. 1D), but which very clearly does not meet all three criteria and is particularly clearly recognizable as a non-triggering case in all four figures, because namely the deformability, especially the particularly early increase in the signals is omitted. The case of an oblique impact according to FIG. 1E shown in FIGS. 6A to 6D, which shows clearly recognizable deflections of the upfront sensors despite a significantly lower speed of “only” 40 km/h, is, in turn, significantly more difficult in terms of case selection. Here, the right-hand side of the vehicle is hit first, but again atypically the opposite, that is to say the left-hand, upfront sensor system initially shows a deflection. However, this does not reach the second threshold value th2, but probably does so on the hit right-hand side (FIG. 6B). However, both the offset criterion with regard to falling below the threshold value th1 and, in particular, the triggering criterion th3 are not met, because in FIG. 6C, the side which was not actually hit (first) does indeed come into the triggering range (dotted), but not with that side which also exceeds the second threshold value (that is to say, on the right-hand side here), i.e., in FIG. 6D, the course remains below the characteristic th3. Overall, this test is a good illustration, once again, of the interaction of the 3 evaluation criteria.

1. A method of controlling an occupant protection device in a motor vehicle, the method comprising:
determining that a first signal of only one of a signal of a left-hand upfront sensor of the motor vehicle or a signal of a right-hand upfront sensor of the motor vehicle is greater than a second threshold value with respect to a signal of the central sensor while a second signal of the other of the first signal and the second signal is less than a first threshold value with respect to the signal of the central sensor;
determining that the first signal exhibits a specified characteristic; and
triggering the occupant protection device in response to (i) determining that the first signal is greater than the second threshold value while the second signal is less than the first threshold value and (ii) determining that the first signal exhibits the specified characteristic.

2. The method according to claim 1, wherein the specified characteristic comprises at least one first section as long as the signal of the central sensor is at least less than a specified limit value,
wherein the triggering comprises triggering in the at least one first section if the first signal exhibits the specified characteristic, and triggering at least one second section, in which the triggering is suppressed as soon as the signal of the central sensor is greater than a specified limit value.

3. The method according to claim 2, wherein the triggering comprises triggering a middle section in which a threshold value for the left-hand upfront sensor and the right-hand upfront sensor, as of which a triggering is carried out, also increases as the signal of the central sensor increases.

4. The method according to claim 3, further comprising:
integrating the signal of the left-hand upfront sensor and the signal of the right-hand upfront sensor are via a short-time integral;
double integrating the signal of the central sensor; and
evaluating a first result of integrating the signal of the left-hand upfront sensor and the signal of the right-hand upfront sensor and a second result of double integrating the signal of the central censor with respect to one another.

5. The method according to claim 4, wherein the occupant protection system comprises a first of a plurality of stages of a driver and/or front passenger airbag as well as a side or window airbag.

6. The method according to claim 5, further comprising:
determining the signal of the central sensor is less than a lower threshold value; and
suppressing triggering of the occupant protection system in response to determining the signal of the central sensor is less than the lower threshold value.

7-8. (canceled)
